(19) United States
(12) Patent Application Publication
(10) Pub. No.: US 2009/0129199 A1
(43) Pub. Date: May 21, 2009

(54) Multi-functional Mixer

(75) Inventors: Kaihsu CHANG, Da Liao Hsiang (TW); Shengfang CHENG, An-Ding Hsiang (TW); Jinhua Liu, Xiamen (CN)

Correspondence Address: KENING LI;PINSENT MASONS, c/o BAKER DONELSON BEARMAN CALDWELL& BERKOWITZ, PC, 555 ELEVENTH STREET, NW, SIXTH FLOOR, WASHINGTON, DC, 20004, US

(73) Assignee: TSANN KUEN (CHINA) ENTERPRISE CO., LTD., Fujian (CN)

(21) Appl. No.: 12/179,665

(22) Filed: Jul. 25, 2008

(30) Foreign Application Priority Data
Jul. 27, 2007 (CN) 200710009301.0

(51) Int. Cl. B01F 13/00; B01F 15/06

(52) U.S. Cl. 366/148; 366/204

(57) ABSTRACT

A multi-functional mixer comprises a housing, the housing having a containing space in which a container is placed; a motor device mounted on the housing; a stirring device connected to the motor device, wherein the stirring device comprises a stirring body and a frothing body driven by the motor and can mix the materials contained in the container. The multi-functional mixer of the present invention can be used for making milk shake and making milk frothing, which offers not only convenience, but also cost saving in making milk shake and milk frothing. The mixer has a steam function as well and can blow steam into the milk shake or the milk frothing, which steam flow can be adjusted through a steam control knob, which can control the temperature of the milk shake or milk frothing, and help frothing formation.

### FIELD OF THE INVENTION

The present invention relates to beverage appliances and, more particularly, to a multi-functional mixer that can be used to make milk shake, milk frothing and to heat the drink.

### BACKGROUND OF THE INVENTION

Milk shake is a kind of semi-fluid mixing dessert which mostly containing milk, and it is usually made by a milk shake machine, the materials in the cup are formed to be milk shake by the stirring movement of the stirring rod of the milk shake machine driven by a motor.

The butter floating on the surface of the coffee can be fresh butter or milk. If the milk is used, it must be stirred to be frothing, such as the frothing in Cappuccino or Latte. The milk can be stirred to be frothing by a milk frother, i.e. the milk be frothed by a frothing rod, the frothing rod has a annular spring, when the spring circumrotated, the milk will be frothed. Some other frothing devices are to insufflate hot steam into the milk to make the milk be frothed; meanwhile the temperature of the milk can be regulated.

The abovementioned milk shaker/milk frother has only single function, so when it needs to make the milk shake and the milk frothing, the two aforementioned devices must be used, this is not only inconvenient, but also rises the making cost. Presently, it is not available to get a device in the market which has both the functions of making milk shake and milk frothing.

### SUMMARY OF THE INVENTION

The major object of the present invention is to provide a multi-functional mixer which obviates the disadvantages of single-function, inconvenient using and high making cost in the existing milk shakers and milk frothers.

The above and other objects of the invention are achieved by providing a multi-functional mixer comprising a housing having a containing space in which a container placed in; a motor mounted on the housing; a stirring device connected to the motor device, the stirring device is driven by the motor to mix materials contained in the container.

Aforementioned multi-functional mixer, the stirring device comprises a driving shaft, a stirring body and a frothing body, said stirring body and said frothing body mounted detachably on the driving shaft respectively.

Aforementioned multi-functional mixer, the stirring device comprises the stirring shaft connected to the stirring body and the frothing shaft connected to the frothing body. The stirring shaft and the frothing shaft are replaceable to each other and are mounted on the motor device.

Furthermore, the said stirring body comprises a sleeve on the lower end of the stirring shaft and two stirring rings integrative-formed on the periphery wall of the sleeve and extending out. The said frothing body comprises a supporting bracket and a frothing spring, the said bracket sheathing on the lower end of the said frothing shaft, there are slots in the two sides of the supporting bracket, the said frothing spring is annular and ringed on the two slots, i.e. the centerline of the frothing spring is a ring, and the plane of the ring is vertical to the frothing shaft.

Still more, the multi-functional mixer further comprises a heating members for providing high-temperature fluid, the liquid spout of the heating members is connected to the container.

The heating members mounted in the said housing comprises a device for producing steam, the steam spout has a steam control valve, and a steam rod extending into the said container for transferring the steam.

And more, the said steam control valve connected with a steam guide rod extending horizontally, the said steam rod rotatably connected to the steam guide rod via a union connection, the said steam control valve has steam adjusting knob, the steam adjusting knob and the union connection positioned to the sides of the said housing respectively; the said steam rod includes a straight section and an arc section, one terminal of the arc section connected to the steam guide rod via the said union connection, the other terminal of the arc section extended into the space of the container and connected to the said straight section, the said arc section has a handle for rotating the steam rod.

The said motor device includes a shell and a motor enclosed in the shell, the lower portion of the rear of shell pivotally connected to the said housing and can swing vertically, the lower portion of the shell formed a containing space for containing the container.

By abovementioned description of the present invention, compared with the prior arts, the present invention has the advantages as follows: firstly, the present invention has two functions, it can be used for making milk shake and making milk frothing, this is not only conveniently used, but also reduces the making cost of the milk shake and milk frothing; secondly, the present invention has the steam function and can blow the steam into the milk shake or the milk frothing, and the steam flow can be adjusted through the steam control knob, thus can control the temperature of the milk shake or milk frothing, and help to form frothing; thirdly, the stirring device and the steam rod can swing vertically for placing the container into the containing space easier, thus enhancing the convenience to use.

### BRIEF DESCRIPTION OF THE INVENTION

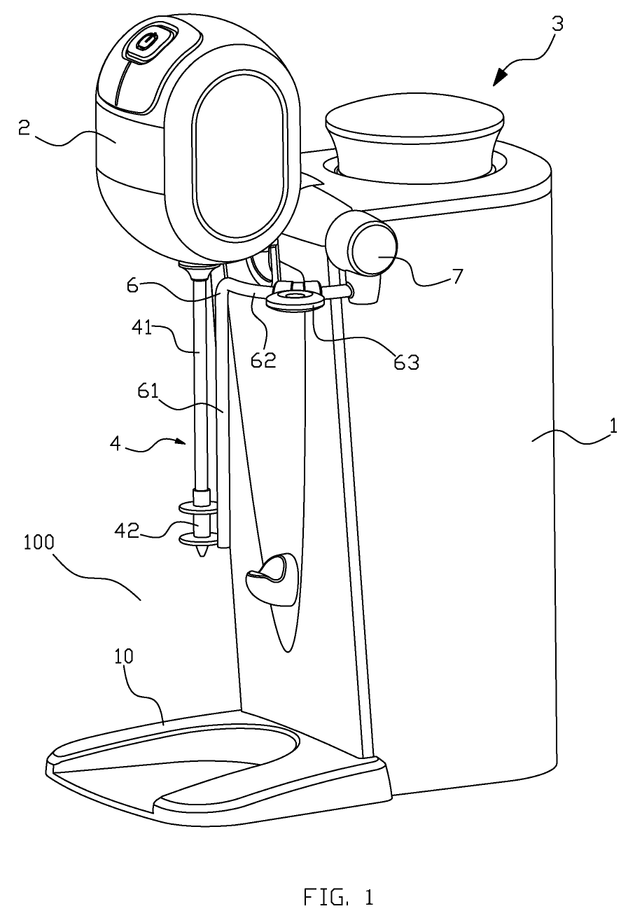

FIG. 1 is a perspective view of the present invention used in making milk shake.

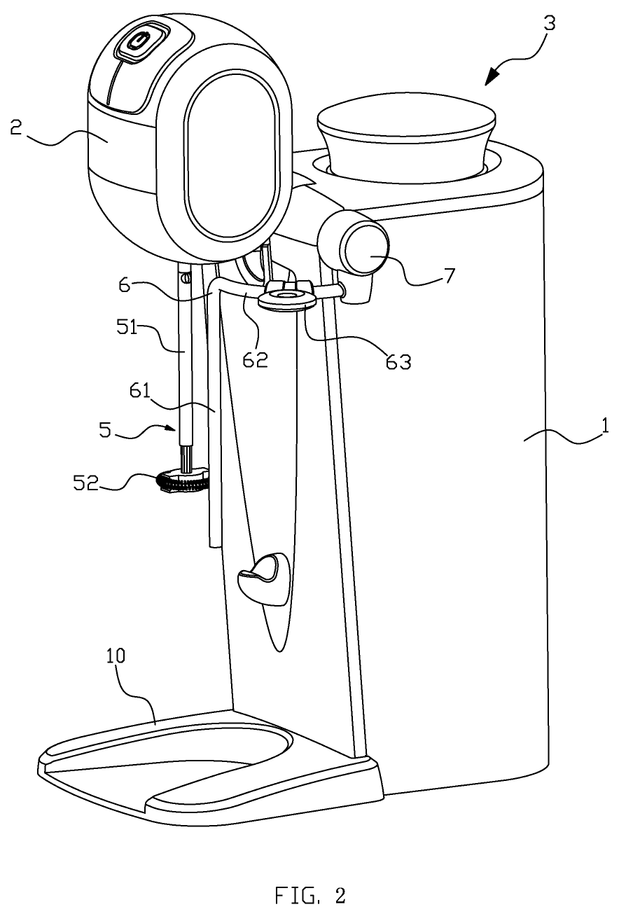

FIG. 2 is a perspective view of the present invention used in making milk frothing.

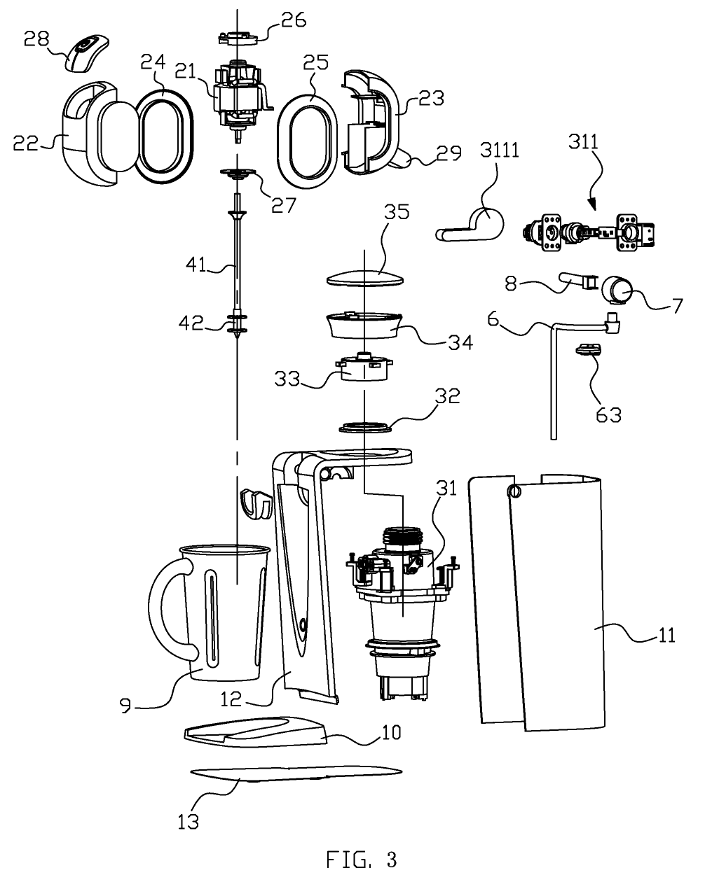

FIG. 3 is an exploded view of the present invention.

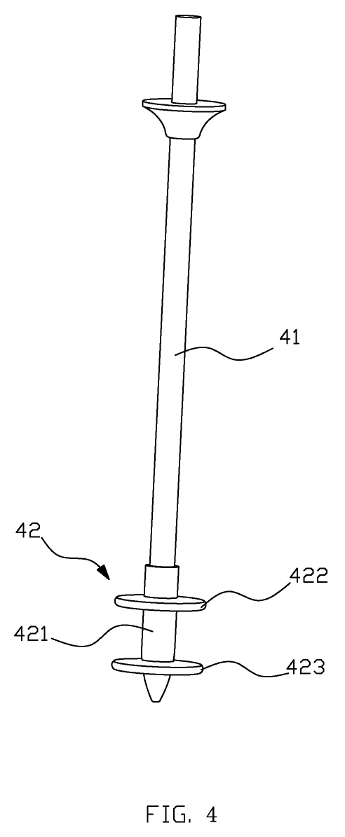

FIG. 4 is a perspective view of the members for making milk shake of the present invention.

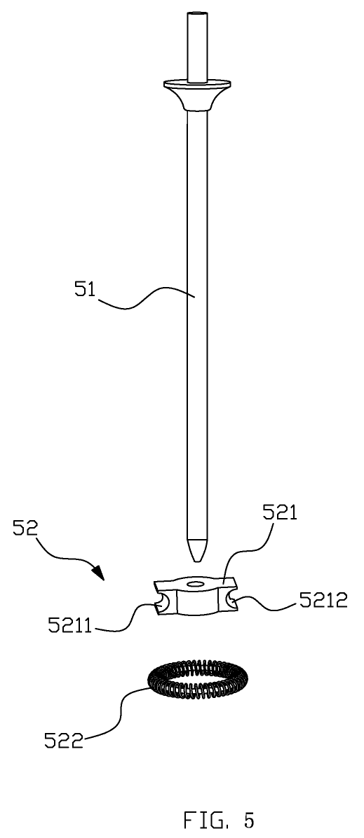

FIG. 5 is a perspective view of the members for making milk frothing of the present invention.

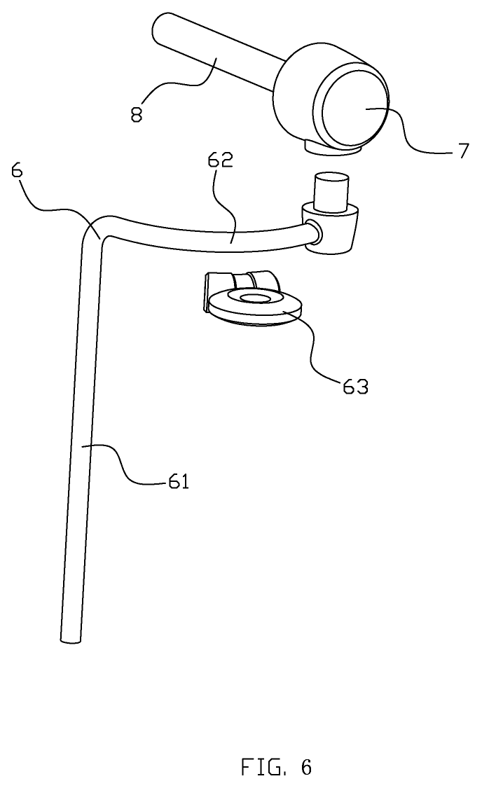

FIG. 6 is an assembly view of the steam pipe of the present invention.

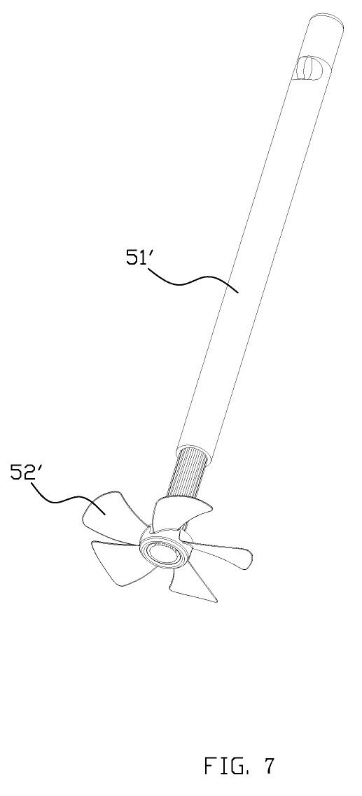

FIG. 7 is another perspective view of the members for making milk frothing of the present invention.

### DETAILED DESCRIPTION OF THE PREFERRED EMBODIMENT

Preferred embodiments of the present invention will be described in detail with reference to the drawings and examples.

Referring to FIG. 1 and FIG. 2, the multi-functional mixer provided in the present invention for making milk shake, milk frothing or hot cocoa drinks etc. comprises a housing 1, the lower portion of the front of the housing 1 connected to a base 10, the base 10 formed a space 100 for containing a container 9, the container 9 is shown in FIG. 3.

Referring to FIG. 1, the housing 1 has a motor device 2 and a stirring device connected to the motor device 2, in this embodiment, the stirring device comprises the interchangeable stirring members 4 and frothing members 5 for making milk shake and milk frothing respectively. By the interchange of the stirring members 4 and frothing members 5, the present mixer can perform the functions of making milk shake and milk frothing.

Referring to FIG. 3, the motor device 2 comprises a shell and a motor 21 enclosed in the shell. The shell includes a butt-jointed front shell 22 and a rear shell 23, and decorating circlets 24, 25 nesting in the left and right sides of the front shell 22 and the rear shell 23; the upper-front of the front shell 22 mounted a control panel 28 for controlling the motor; the output shaft of the motor 21 extends downwardly, the top and the bottom of the motor 21 mounted anti-vibration pads 26, 27 respectively. The shell pivotally connected to the upper portion of the front of the housing 1 swingable to the vertical direction via a hinged protruding portion 29 in the lower portion of the rear of the rear shell 23. The space 100 for containing container 9 formed between the shell and the base 10.

Referring to FIG. 1, FIG. 3 and FIG. 4, aforementioned stirring members comprise a stirring shaft 41 detachably connected to the output shaft of the motor 21 and a stirring body 42 connected to the lower end of the stirring shaft 41. The stirring body includes a sleeve 421 sheathing on the lower end of the stirring shaft 41 and two stirring rings 422, 423 integrative formed in the periphery wall of the sleeve 421 and extending out. When the stirring shaft 41 rotated, the stirring body 42 can make milk shake.

Referring to FIG. 2 and FIG. 5, the said frothing members 5 comprises a frothing shaft 51 detachably connected to the output shaft of the motor 21 and is interchangeable with the stirring shaft 4, and comprises a frothing body 52 connected to the lower end of the frothing shaft. The frothing body 52 include a bracket 521 and a frothing spring 522, the said bracket 521 sheathing on the lower end of the said frothing shaft 51, the two sides of the bracket 521 mounted slots 5211, 5212, the said frothing spring 522 is annular, and ringed in the slots 5211 and 5212, i.e. the centerline of the frothing spring is a ring, and the plane of the ring is vertical to the frothing shaft 51. When the frothing shaft 51 rotated, the frothing body 52 can make milk frothing. It should be noted that either one of the stirring shaft 41 or the frothing shaft 51 can be used as a driving shaft to connect either one of the stirring body 42 or the frothing body 52 to make beverages.

Referring to FIG. 3, the housing 1 comprises an enclosure wall 11, a top board 12 and a bottom board 13, the enclosure wall 11 formed the left, right and rear side walls of the housing 1, the top board 12 formed the top wall and front wall of the housing 1, the bottom board 13 formed the bottom wall of the housing 1. Referring to FIG. 1, FIG. 2 and FIG. 3, the multi-functional mixer further comprises heating members 3 inside the housing 1, the heating members 3 comprising a boiler 31 for generating steam, a seal 32, a boiler cover 33, top covers 34, 35, mounted on the water inlet in turn. The steam outlet of the boiler 31 has a steam control valve 311 and a steam rod 6 extending into the said container 9 for transferring the steam. And referring to FIG. 6 also, the steam control valve 311 connected with a steam guide rod 8 extending horizontally, the said steam rod 6 rotatably connected to the guide rod 8 by a union connection 7, the said steam control valve 311 has steam adjusting knob 3111 for controlling the steam flow from the steam outlet, the steam adjusting knob 3111 and the union connection 7 positioned to the left and right side of the said housing 1 respectively; the steam rod 6 includes a straight section 61 and an arc section 62, one terminal of the arc section 62 connected to the guide rod 8 via the said union connection 7, the other terminal of the arc section extended into the space 100 of the container 9 and connected to the said straight section 61, the said arc section 62 has a handle 63 for rotating the steam rod 6, i.e. the steam rod 6 can be rotated up and down relative to union connections 7.

It is obvious that the stirring device and the steam rod 6 can be rotated up and down for the convenience of putting the container 9 into the space 100.

Additionally, the frothing body is not limited within the abovementioned structures, all the structures that can froth the materials in the container 9 can be used herein, e.g. the structure shown in FIG. 7, an impeller 52′ mounted in the lower end of the frothing shaft 51′, and the impeller 52′ has helical blades.

In the aforementioned embodiments, the mixer can perform the functions of making milk shake and milk frothing by the interchange between the stirring members 4 and the stirring members 5. But without limitation, in another embodiment only inter-replace the stirring body 42 and the frothing body 52, while the stirring shaft 41 and the frothing shaft 51 use the same driving shaft, and not need to be replaced.

The above-mentioned descriptions are of exemplary embodiments only, and are not intended to limit the scope, applicability or configuration of the invention in any way. All changes that come within the meaning and range of equivalency of the claims are to be embraced within their scope.

What is claimed is:

1. A multi-functional mixer, comprising:
a housing having a containing space in which a container is placed;
a motor mounted on the housing;
a stirring device connected to the motor device, wherein the stirring device is driven by the motor to mix materials contained in the container.

2. The multi-functional mixer according to claim 1, wherein the stirring device comprises a driving shaft, a stirring body and a frothing body, said stirring body and said frothing body mounted detachably on the driving shaft respectively.

3. The multi-functional mixer according to claim 1, wherein the stirring shaft is connected to the stirring body and the frothing shaft is connected to the frothing body.

4. The multi-functional mixer according to claim 3, wherein the stirring shaft and the frothing shaft are replaceable to each other and are mounted on the motor device.

5. The multi-functional mixer according to claim 4, wherein the stirring body comprises a sleeve on the lower end of the stirring shaft and two stirring rings integrally-formed on the periphery wall of the sleeve and extending out.

6. The multi-functional mixer according to claim 4, wherein the frothing body comprises a supporting bracket and a frothing spring, said bracket sheathing on the lower end of the said frothing shaft, wherein there are slots on the two sides of the supporting bracket, said frothing spring is annular and ringed on the two slots, the centerline of the frothing spring is a ring, and the plane of the ring is vertical to the frothing shaft.

7. The multi-functional mixer according to claim 1 which further comprises a heating member for proving a high-temperature fluid, wherein a liquid spout of the heating member is connected to the container.

8. The multi-functional mixer according to claim 7, wherein the heating member mounted in the said housing further comprises a device for producing steam, the device comprising a steam spout having a steam control valve, and a steam rod extending into the container for transferring the steam.

9. The multi-functional mixer according to claim 8, wherein the steam control valve is connected with a steam guide rod extending horizontally, said steam rod is rotatably connected to the steam guide rod via a union connection, said steam control valve has a steam adjusting knob, the steam adjusting knob and the union connection positioned to the sides of the housing respectively; the steam rod includes a straight section and an arc section, one terminal of the arc section connected to the steam guide rod via the union connection, the other terminal of the arc section extended into the space of the container and connected to said straight section, said arc section has a handle for rotating the steam rod.

10. The multi-functional mixer according to claim 7, wherein the motor device comprises a shell and a motor enclosed in the shell, a lower portion of the rear of the shell is pivotally connected to the housing and can swing vertically, the lower portion of the shell formed a containing space for containing the container.
